(19) United States
(12) Patent Application Publication
(10) Pub. No.: US 2003/0047820 A1
(43) Pub. Date: Mar. 13, 2003

(54) Packing module, method for making same, and fluid treating apparatus comprising a corresponding packing

(76) Inventors: Jean-Yves Lehman, Maisons Alfort (FR); Etienne Werlen, Paris (FR)

Correspondence Address: Air Liquide, Intellectual Property Department, Suite 1800, 2700 Post Oak Boulevard, Houston, TX, 77056, US

(21) Appl. No.: 10/239,017

(22) PCT Filed: Mar. 15, 2001
(86) PCT No.: PCT/FR01/00782

(30) Foreign Application Priority Data
Mar. 17, 2000 (FR) 00/03480

(51) Int. Cl. B01F 3/04

(52) U.S. Cl. 261/94; 261/DIG. 72

(57) ABSTRACT

The invention concerns a packing module (2) comprising an assembly of deflectors (7, 9, 11) which define a set of horizontal layers of fixed mixing ventilators (3, 4, 5). In at least one axial end zone (6) of the module, the deflectors constitute transition deflectors (9, 11) defining at least one layer of fixed transition ventilators (4, 5) whereof the mixing effect is reduced relative to that of the layers (3) located in the current part of the module. The invention is useful for air distillation columns.

The present invention relates to a packing module, of the type comprising a set of deflectors which define a set of horizontal layers of stationary mixing ventilators.

The term “packing” refers to a device designed to blend one phase and/or to bring into contact several phases flowing co-currentwise or counter-currentwise. In particular, exchange of heat and/or of mass and/or a chemical reaction may occur in the packing. A particular application of the invention lies in air distillation columns.

The packing modules or packings of the aforementioned type are structures having a three-dimensional effect on the gas which rises in the column. They provide, by multiple rotation of the gas, high turbulence in this gas, and the resulting mixing improves the exchange of heat and/or of mass with the descending liquid.

Examples of such packings are described in WO-A-86/06 296. In these known packings, the structure comprises pyramids with open bases, and with lateral faces which are alternatively open and closed, connected by their tips so as to constitute a multitude of ventilator blades rotating the gas in order to intensify the contact between the gas and the liquid. A particularly beneficial characteristic of this structure is that it can be obtained by stacking perforated or cut and folded metal sheets having overall vertical planes. The perforation allows the gas to pass through the stacked folded strips, the degree of perforation being about 50%. These perforations enable the pressure drop to be reduced and ventilators promoting mixing of the gas to be created.

Other packings of the aforementioned type are described in WO-A-90/10 497 and in EP-A-845 293.

In particular, the invention is applicable to all these known devices.

When a fluid treatment column is produced with such packings, the upper ventilators of a packing are not exactly superimposed with the similar lower ventilators of the packing located just above. Likewise, the lower ventilators of a packing are not exactly superimposed with the similar upper ventilators of the underlying packing. This is even more true when, from one packing to the next, the overall planes of the folded strips are generally offset angularly with respect to the central axis of the column, generally by 90° from one packing to another.

As a result, the ascending stream of gas undergoes changes in direction at the interface between two packings, which produces an additional pressure drop at this location. This pressure drop in turn causes the lower region of the upper packing to be flooded with liquid, while the central part of this packing is not flooded. This phenomenon decreases the treatment capacity of the column.

The aim of the invention is to reduce, or even to eliminate, this additional pressure drop and the premature flooding at the interfaces between the packings.

To this end, the subject of the invention is a packing module of the aforementioned type, characterized in that, in at least one axial end zone of the module, the deflectors constitute transition deflectors defining at least one layer of stationary transition ventilators whose mixing effect is reduced in comparision with that of the standard ventilators of the layers located in the standard part of the module.

The subject of the invention is also a flat strip cut from sheet material, especially thin sheet metal, intended to be folded and/or bent, twisted or stamped, then juxtaposed with other similar strips in an overall vertical plane, alternately turned back, in order to constitute a packing module as defined above. This strip, of the type defining a plurality of horizontal rows of deflectors, is characterized in that, in at least one marginal zone of the strip, the deflectors have a configuration which is different from that of the standard deflectors, defining said transition deflectors.

The subject of the invention is also a method of manufacturing a packing module as defined above. According to this method, a series of flat strips cut as defined above is folded and/or bent, twisted or stamped so as to form a concertina structure, the strips are placed in parallel planes by turning them back alternately, and they are stacked by aligning the corresponding deflectors in order to form the ventilators.

Yet another subject of the invention is a fluid treatment apparatus, characterized in that it comprises a plurality of packing modules as defined above. The modules may be angularly offset from one module to the next about the central axis of the apparatus.

This apparatus may especially be a column for exchanging mass and/or heat, especially a column for separating a gas blend and in particular an air distillation column.

Exemplary embodiments of the invention will now be described with regard to the appended drawings, in which:

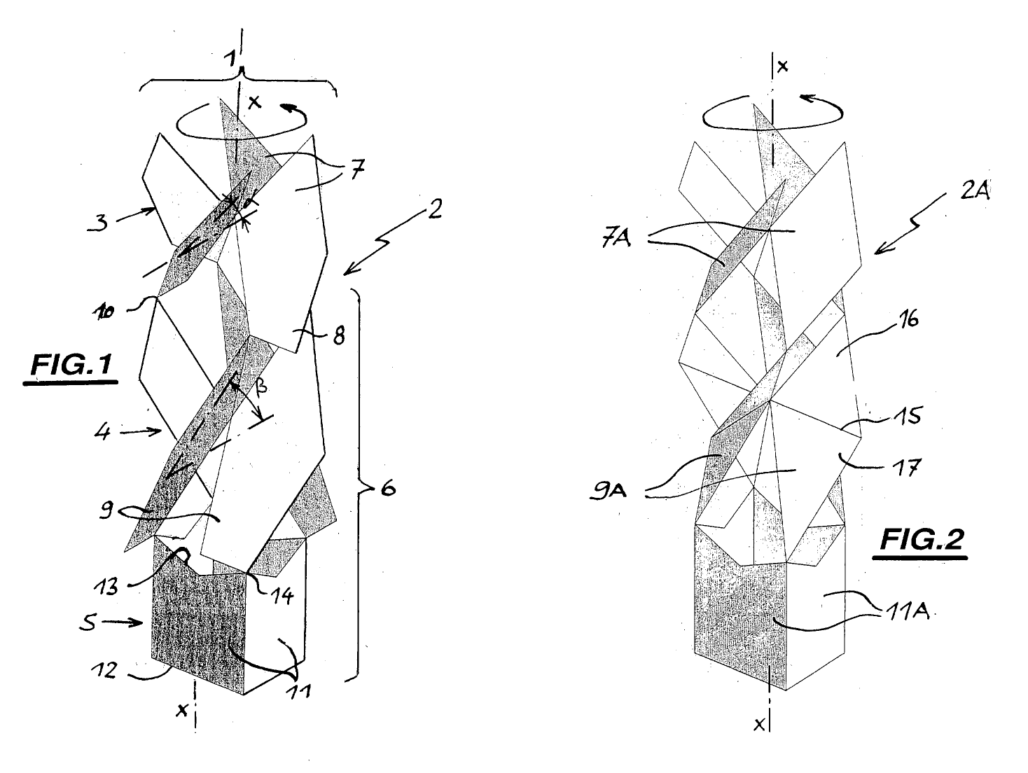

FIG. 1 is a perspective view of part of a packing according to the invention;

FIG. 2 is a similar view of a variant;

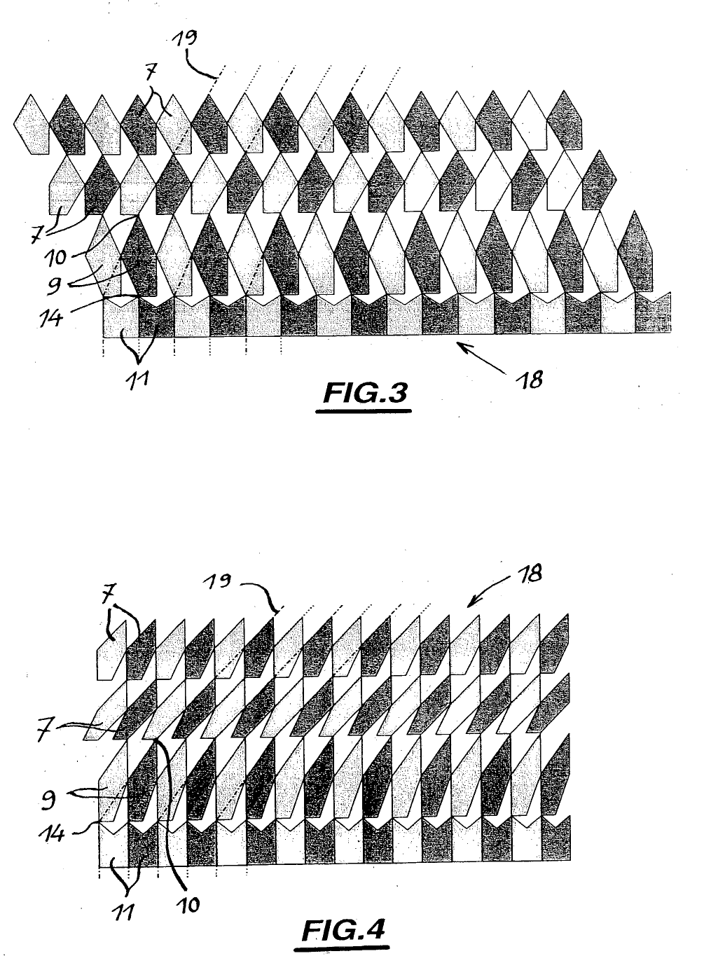

FIG. 3 is a view of a cut flat strip designed for producing the packing of FIG. 1;

FIG. 4 is a view of the same strip after folding into a concertina; and

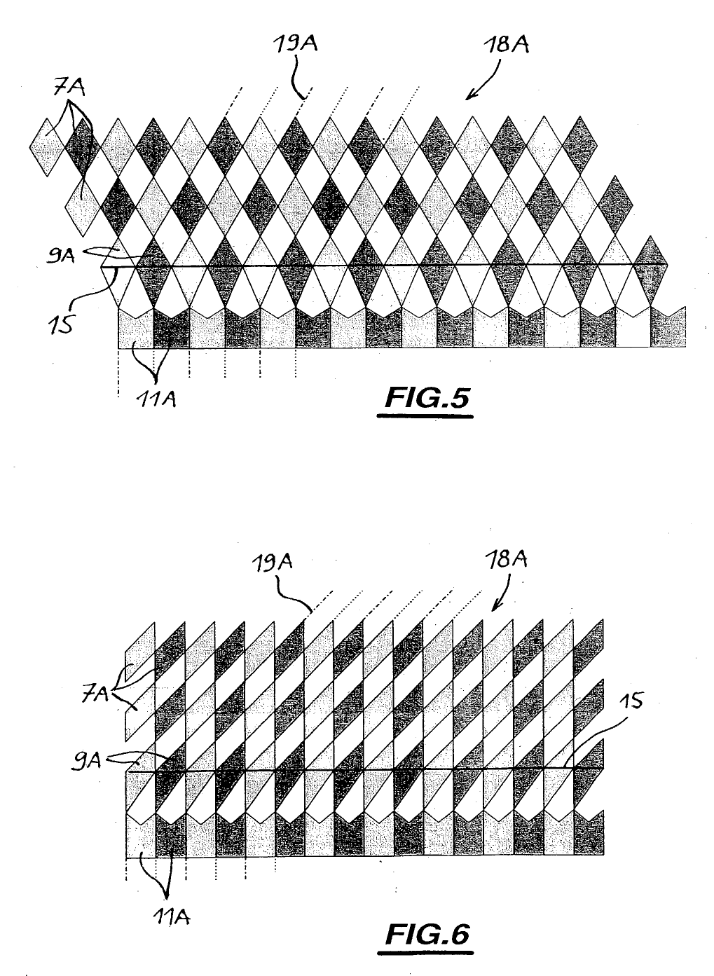

FIGS. 5 and 6 are views corresponding to FIGS. 3 and 4, respectively, but relating to the variant of FIG. 2.

FIG. 1 shows the lower part of a vertical portion 1 of a packing 2 designed for an air distillation column (not shown). The portion 1 defines a superposition of ventilators, that is to say a standard ventilator 3 surmounted by other identical ventilators (not shown), and two transition ventilators, an intermediate 4 and extreme 5 ventilator, which are part of a lower end zone 6 of the packing. The ventilators 3 to 5 have a common vertical axis X-X.

The ventilator 3 consists of four flat blades or deflectors 7, inclined at the same angle α to the horizontal. The orientations of these blades are inferred from one another by a rotation of 90° about the axis X-X, and each blade has the shape of a lozenge extended downward by a triangular tip 8, adjacent to a lower side of the lozenge, as described in the aforementioned document EP-A-845 293.

The ventilator 4 consists of four blades or deflectors 9 similar to the blades 7 but more steeply inclined to the horizontal, at an angle β which is greater than a. Seen along the axis X-X, it falls within the same perimeter as the ventilator 3, such that the vertical height of each blade 9 is greater than that of each blade 7. Each of the upper tips of the blades 9 are connected to a lower tip of the lozenge of a corresponding blade 7 by means of a thin connection zone 10.

As a result, the ventilator 4 has a rotating, and therefore mixing, effect on the ascending gas flow, which effect is positive but less than that of the ventilator 3, and directed in the same sense, which is the anticlockwise sense in the example shown.

The ventilator 5 consists of four rectangular-shaped vertical blades or deflectors 11, with a horizontal lower edge 12 and an upper edge 13 which is recessed into a V shape. The tips of the Vs are connected to the lower tips of the respective blades 9 by a thin connection zone 14.

Thus, the ventilator 5 has a zero rotational effect.

The portion 1 is repeated many times over the entire cross section of the packing 2. The diameter of this portion is typically between 1 and 4 cm.

The packing 2 may be autonomous and fitted with cylindrical hooping optionally provided in its upper edge with several vertical slots in order to define a small relative sealing brush adapted to cooperate with the inner wall of the column, as is known per se.

If the column diameter is large, the packing can be produced by blocks assembled in situ, also as is known per se.

In all cases, the packing 2 therefore comprises at its base a layer without any mixing effect consisting of the ventilators 5, then an intermediate layer consisting of the ventilators 4, with a small mixing effect, then a plurality of layers of standard ventilators 3 with a strong mixing effect. Preferably, the upper end zone of the packing consists of a transition zone identical to the zone 6 but turned over.

The other packings of the column are constructed in the same way.

Thus, the gas rising in the column, made to rotate vigorously within a packing 2 by the ventilators 3, sees its rotation slowed down on passage through the ventilators 4, then stopped on passage through the ventilators 5.

It therefore emerges from the packing substantially vertically and enters the ventilators 5 of the upper packing without changing direction. Then it is rotated slowly by the ventilators 4 of this upper packing, then rotated vigorously by the ventilators 3.

The pressure drop on passing from one packing to the next is thus virtually eliminated; consequently, the premature flooding of the lower region of the packing is also virtually eliminated. Overall, a saving both in the overall pressure drop in the column and in the treatment capacity thereof is obtained.

FIG. 2 shows a variant 2A of the packing in which the blades 7A and 9A do not have the lower point such as 8. Furthermore, the increase in the inclination of the blades 9A is obtained by folding these blades along a diagonal line 15 having an orientation close to the horizontal. Each blade 9A thus comprises a triangular upper part 16 of inclination α and a triangular lower part 17 of inclination β which is greater than α. The lower ventilators 5A are identical to the ventilators 5 of FIG. 1, with four vertical blades 11A.

As a variant, the blades 9A may be at least partly curved in order to define the increased inclination of their lower part.

FIG. 3 shows a flat strip 18 of thin sheet metal intended for producing the packing 2 of FIG. 1. This strip is cut or perforated so as to leave only the blades 7, 9 and 11. By following the left edge of these blades, a large number of broken folding lines such as 19 are defined, with, for each of these lines, a first bend at the connection tip 10 and a second bend at the connection tip 14.

The strip 18 is folded into a concertina around the lines 19, which leads, seen from the front, to the configuration of FIG. 4.

The packing 2 consists of a plurality of strips 18 thus obtained, each one placed in an overall vertical plane, turned back alternately about a vertical axis and stacked with alignment and interpenetration of the blades so as to constitute the ventilators 3, 4 and 5. Thus, in FIG. 1, for each ventilator, the two blades located at the first level belong to a first strip 18 and those located at the second level belong to a second strip 18.

Likewise, FIGS. 5 and 6 show a strip 18A cut so as to leave only the blades 7A, 9A and 11A of FIG. 2. The concertina folding is similar to that above, but with, in addition, at each folding step along a broken line 19A, an additional folding along the diagonal 15, which is initially horizontal, of the adjacent blade 9A.

As will be understood, the upper and/or lower axial end zone of the packings with gradual mixing may comprise any suitable number of layers, and, in this zone, the intensity of the mixing may be modified either from one layer to the next, or from one group of layers to another group of layers.

1. A packing module, of the type comprising a set of deflectors (7, 9, 11; 7A, 9A, 11A) which define a set of horizontal layers of stationary mixing ventilators (3, 4, 5), characterized in that, in at least one axial end zone (6) of the module (2), the deflectors (9, 11; 9A, 11A) constitute transition deflectors defining at least one layer of stationary transition ventilators (4, 5) whose mixing effect is reduced compared to that of the standard ventilators (3) of the layers located in the standard part of the module.

2. The packing module as claimed in claim 1, characterized in that at least one layer of transition ventilators (4) has a positive mixing effect.

3. The packing module as claimed in claim 2, characterized in that each ventilator (4) of said transition layer with a positive mixing effect falls, along its axis (X-X), within the same perimeter as the standard ventilators (3) of the module located above or below.

4. The packing module as claimed in claim 2 or 3, characterized in that, in said end zone (6), the transition deflectors (9, 11; 9A, 11A) define several layers of stationary transition ventilators (4, 5) whose mixing effect is gradually reduced from one layer to the other when going toward the end section of the module.

5. The packing module as claimed in any one of claims 1 to 4, characterized in that said end zone (6) comprises an end layer (5) with zero mixing effect.

6. The packing module as claimed in any one of claims 1 to 5, characterized in that the transition deflectors (9, 11; 9A, 11A) comprise at least one part which is more steeply inclined to the horizontal than the standard deflectors (7; 7A).

7. The packing module as claimed in any one of claims 1 to 6, characterized in that the deflectors (7, 9, 11) are flat and, in said end zone (6), are more steeply inclined to the horizontal.

8. The packing module as claimed in any one of claims 1 to 7, characterized in that transition deflectors (9A) comprise a part (17) on the outside of the module which is more steeply inclined to the horizontal than their part (16) on the inside of the module.

9. The packing module as claimed in claim 8, characterized in that transition deflectors (9A) have an intermediate folding line (15) between said parts (16 and 17).

10. The packing module as claimed in claim 8, characterized in that transition deflectors have at least one curved part.

11. A flat strip cut from sheet material, especially thin sheet metal, intended to be folded and/or bent, twisted or stamped, then juxtaposed with other similar strips in an overall substantially vertical plane, alternately turned back, in order to constitute a packing module (2; 2A) as claimed in any one of claims 1 to 10, of the type defining a plurality of horizontal rows of deflectors (7, 9, 11; 7A, 9A, 11A), characterized in that, in at least one marginal zone of the strip (18; 18A), the deflectors have a configuration which is different from that of the standard deflectors (7; 7A), defining said transition deflectors (9, 11; 9A, 11A).

12. The strip as claimed in claim 11, characterized in that the edges located on one and the same side of the standard deflectors (7, 7A) and of the transition deflectors (9, 11; 9A, 11A) define folding lines (19; 19A) whose angle with respect to the longitudinal direction of the strip (18; 18A) is increased in said marginal region of the strip.

13. The strip as claimed in claim 12, characterized in that said folding lines (19; 19A) form a broken line.

14. A method of manufacturing a module (2; 2A) as claimed in any one of claims 1 to 10, characterized in that a series of flat strips cut as claimed in any one of claims 9 to 11 is folded and/or bent, twisted or stamped so as to form a concertina structure, the strips are placed in parallel planes by turning them back alternately, and they are stacked by aligning the corresponding deflectors (7, 9, 11; 7A, 9A, 11A) in order to form the ventilators (3, 4, 5).

15. The method as claimed in claim 14, characterized in that the concertina structures are formed by folding the strips (18; 18A) along the folding lines (19; 19A) defined by the edges located on one and the same side of the standard deflectors (7; 7A) and of the transition deflectors (9, 11; 9A, 11A).

16. A fluid treatment apparatus, characterized in that it comprises a plurality of packing modules (2; 2A) as claimed in any one of claims 1 to 10.

17. The apparatus as claimed in claim 16, characterized in that the modules are offset angularly from one module to the next about the central axis of the apparatus.

18. The apparatus as claimed in claim 16 or 17, characterized in that it constitutes a column for exchanging mass and/or heat, especially for separating a gas blend and in particular an air distillation column.
